(19) United States
(12) Patent Application Publication
(10) Pub. No.: US 2009/0040584 A1
(43) Pub. Date: Feb. 12, 2009

(54) LIGHT SCANNING UNIT, CONTROL METHOD THEREOF, AND IMAGE FORMING APPARATUS HAVING THE SAME

(75) Inventor: Hyun-jin HAN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/164,365

(22) Filed: Jun. 30, 2008

(30) Foreign Application Priority Data
Aug. 10, 2007 (KR) 2007-80645

(51) Int. Cl. G02B 26/08

(52) U.S. Cl. 359/212

(57) ABSTRACT

A light scanning unit includes a light source, a beam deflecting unit which reciprocatingly scans a light beam which is emitted from the light source to form an image sector and a first non-image sector and a second non-image sector disposed at opposite sides of the image sector, a sensor which senses the light beam which is deflected and scanned toward the first non-image sector, and a controller which adjusts a horizontal synchronization of the image sector which is formed by the light beam which is scanned in a first direction and a second direction which is the opposite direction to the first direction based on a time period of a signal which is outputted from the sensor.

### CROSS-REFERENCE TO RELATED APPLICATIONS

This application claims priority from Korean Patent Application No. 10-2007-0080645, filed on Aug. 10, 2007 in the Korean Intellectual Property Office, the disclosure of which is incorporated herein by reference in its entirety.

### BACKGROUND OF THE INVENTION

1. Field of the Invention

The present general inventive concept relates to a light scanning unit, a control method thereof and an image forming apparatus having the same, and more particularly, to a light scanning unit, a control method thereof and an image forming apparatus having the same that performs a horizontal synchronization of an image sector when a light beam is reciprocatingly scanned to an image carrying body.

2. Description of the Related Art

A light scanning unit is applied to an image forming apparatus such as a laser beam printer, a digital copier, a facsimile, etc., and deflects a light beam emitted from a light source supplied with an image signal to be scanned in a main scanning direction of an image carrying body. An electrostatic latent image is formed on the image carrying body by means of a main scanning based on the light scanning unit and a sub scanning based on movement of the image carrying body.

The light scanning unit includes a beam deflecting unit to deflect the light beam emitted from the light source, and in the beam deflecting unit, there are a polygon mirror type scanning the light beam in a single direction, and a resonance mirror type reciprocatingly scanning the light beam in right and reverse directions.

Since the light beam is reciprocatingly scanned in the beam deflecting unit of the resonance mirror type, after a scanning direction is recognized before the light beam is scanned to an image sector, an image information corresponding to the scanning direction is applied to the light source. Also, it is necessary that a plurality of image sectors formed by the light beam to form an electrostatic latent image are aligned along a sub scanning direction. That is, it is necessary that a horizontal synchronization of the image sector is accomplished.

In the conventional light scanning unit, two sensors are respectively disposed in a pair of non image sectors formed at opposite sides of the image sector. These two sensors sense the light beam scanned to each non image sector to output different signals, and the scanning direction is recognized based thereon to adjust the horizontal synchronization of the image sector.

However, in the conventional light scanning unit, since the sensor is provided in two or more locations, a manufacturing cost of the apparatus increases, and an additional installation space is necessary. Also, an electrical connecting configuration is necessary to transmit signals outputted from the two or more sensors, and a configuration is necessary to discern different signals outputted from each sensor. Accordingly, a configuration of the apparatus is complicated, and it makes it difficult to make the apparatus small.

### SUMMARY OF THE INVENTION

The present general inventive concept provides a light scanning unit, a control method thereof and an image forming apparatus having the same employing a single sensor to perform a horizontal synchronization of an image sector which is formed as a light beam is reciprocatingly scanned, and disposed in parallel in a sub scanning direction.

The present general inventive concept also provides a light scanning unit, a control method thereof and an image forming apparatus having the same that recognizes a scanning direction of a light beam reciprocatingly scanned by means of a single sensor.

Additional aspects of the present general inventive concept will be set forth in part in the description which follows and, in part, will be obvious from the description, or may be learned by practice of the present general inventive concept.

The foregoing and/or other aspects and utilities of the present general inventive concept can be achieved by providing a light scanning unit, including a light source, a beam deflecting unit which reciprocatingly scans a light beam which is emitted from the light source to form an image sector, and a first non-image sector and a second non-image sector disposed at opposite sides of the image sector, a sensor which senses the light beam which is deflected and scanned toward the first non-image sector, and a controller which adjusts a horizontal synchronization of the image sector which is formed by the light beam which is scanned in a first direction and a second direction which is the opposite direction to the first direction based on a time period of a sensor output signal which is outputted from the sensor.

The controller may adjust a scanning starting point of time and a scanning ending point of time of the light beam of the image sector to correspond to a driving frequency of the beam deflecting unit and the time period of the sensor output signal.

If a first line may a line which connects the sensor to a reference point at which an entering light beam is reflected by the beam deflecting unit, a second line is a line which connects the reference point to an end of the first non-image sector which does not contact the image sector, and a third line is a line which connects the reference point to an end of the second non-image sector which does not contact the image sector, and where the controller may calculate a time band T1 during which the light beam returns to the first line after being scanned from the first line to the second line, and a time band T2 during which the light beam returns to the first line after moving from the first line to the third line.

The time bands T1 and T2 may satisfy an inequality T1<T2.

The controller may measure a time difference of the sensor output signal in real time, and may compare the measured time difference in real time to determine which one of the time bands T1 and T2 is substantially the same as the measured time difference.

The controller may divide a time zone in which the light beam is scanned in the first direction and the second direction in sequence during the time band T2 to form the image sector based on the driving frequency of the beam deflecting unit and the time period of the sensor output signal.

The time band T2 may be divided into a time K during which the light beam is scanned from a starting point of the time band T2 to a starting point of the image sector, a time L during which the light beam is scanned to the image sector, and a time M during which the light beam is scanned to the second non-image sector.

The controller may measure the time difference of the sensor output signal in real time, and may scan for the time L the light beam which includes an image information which corresponds to the first direction after the time K from the starting point of the time band T2 if the measured time difference is substantially the same as the time band T1.

The controller may scan for the time L the light beam which includes an image information which corresponds to the second direction after a time K+L+2M from the starting point of the time band T2.

The time band T2 may be divided into a time K1 during which the light beam is scanned from a starting point of the time band T2 to a starting point of the image sector, a time Q which is a scanning time between a scanning ending point of the first direction and a scanning starting point of the second direction of the image sector, and a time K2 which is a scanning time between a scanning ending point of the second direction of the image sector and an ending point of the time band T2.

The controller may measure the time difference of the sensor output signal in real time, and may scan the light beam which includes an image information which corresponds to the first direction to the image sector after the time K1 from the starting point of the time band T2 if the measured time difference is substantially the same as the time band T1.

The controller may scan the light beam which includes an image information which corresponds to the second direction to the image sector after a time Q+(K2−K1) from the scanning ending point of the first direction of the light beam.

The beam deflecting unit may include a resonance mirror.

The foregoing and/or other aspects and utilities of the present general inventive concept can be achieved by providing an image forming apparatus, including an image carrying body; a light scanning unit to scan a light beam to the image carrying body to form a latent image, the light scanning unit including a light source, a beam deflecting unit which reciprocatingly scans a light beam which is emitted from the light source to form an image sector on the image carrying body, and a first non-image sector and a second non-image sector disposed at opposite sides of the image sector on the image carrying body, a sensor which senses the light beam which is deflected and scanned toward the first non-image sector, and a controller which adjusts a horizontal synchronization of the image sector which is formed on the image carrying body by the light beam which is scanned in a first direction and a second direction which is the opposite direction to the first direction based on a time period of a sensor output signal which is outputted from the sensor, a developing unit to supply a developer to the image carrying body to form a visible image thereon, a transferring unit to transfer the visible image of the image carrying body on a printing medium; and a fusing unit to fuse the visible image on the printing medium.

The beam deflecting unit may include a resonance mirror.

The foregoing and/or other aspects of the present general inventive concept may also be achieved by providing a control method of a light scanning unit which includes a light source, and a beam deflecting unit which reciprocatingly scans a light beam which is emitted from the light source in a first direction and a second direction which is the opposite direction to the first direction to form an image sector and first and second non-image sectors to the opposite sides of the image sector, the control method of the light scanning unit including: sensing the light beam which is deflected and scanned toward the first non-image sector by means of a sensor, and calculating a time period of a sensor output signal which is outputted from the sensor, and adjusting a horizontal synchronization of the image sector which is scanned in sequence in the first direction and the second direction to correspond to the time period of the sensor output signal.

The adjusting the horizontal synchronization may include adjusting a scanning starting point of time and a scanning ending point of time of the light beam of the image sector to correspond to a driving frequency of the beam deflecting unit and the time period of the sensor output signal.

If a first line may be a line which connects the sensor to a reference point at which an entering light beam is reflected by the beam deflecting unit, a second line is a line which connects the reference point to an end of the first non image sector which does not contact to the image sector, and a third line is a line which connects an end of the second non image sector which does not contact to the image sector to the reference point, and where the calculating the time period includes calculating a time band T1 during which the light beam returns to the first line after being scanned from the first line to the second line, and a time band T2 during which the light beam returns to the first line after moving from the first line to the third line.

The time bands T1 and T2 may satisfy an inequality T1<T2.

The calculating the time period may further include dividing a time zone in which the light beam is scanned in the first direction and the second direction in sequence in the time band T2 to form the image sector based on the driving frequency of the beam deflecting unit and the time period of the sensor output signal.

The dividing the time zone may include dividing the time band T2 into a time K during which the light beam is scanned from a starting point of the time band T2 to a starting point of the image sector, a time L during which the light beam is scanned to the image sector, and a time M during which the light beam is scanned to the second non image sector.

The adjusting the horizontal synchronization may include measuring a time difference of the sensor output signal in real time, and scanning for the time L the light beam which includes an image information which corresponds to the first direction after the time K from the starting point of the time band T2 if the measured time difference is substantially the same as the time band T1.

The adjusting the horizontal synchronization may further include scanning for the time L the light beam which includes an image information which corresponds to the second direction after a time K+L+2M from the starting point of the time band T2.

The dividing the time zone may include dividing the time band T2 into a time K1 during which the light beam is scanned from a starting point of the time band T2 to a starting point of the image sector, a time Q which is a scanning time between a scanning ending point of the first direction and a scanning starting point of the second direction of the image sector, and a time K2 which is a scanning time between a scanning ending point of the second direction of the image sector and an ending point of the time band T2.

The adjusting the horizontal synchronization may include measuring the time difference of the sensor output signal in real time, and scanning the light beam which includes an image information which corresponds to the first direction to the image sector after the time K1 from the starting point of the time band T2 if the measured time difference is substantially the same as the time band T1.

The adjusting the horizontal synchronization may further include scanning the light beam which includes an image information which corresponds to the second direction to the image sector after a time Q+(K2−K1) from the scanning ending point of the first direction of the light beam.

The beam deflecting unit may include a resonance mirror.

The foregoing and/or other aspects of the present general inventive concept may also be achieved by providing method to control a light scanning unit of an image forming device, including calculating a scanning angle pattern of a reflected light beam which moves over time with reference to a reference scanning angle as the reflected light beam reciprocatingly moves from a first area of an image carrying body to a second and then a third area of the image carrying body, and controlling the reflected light beam to form a latent image only on the second area of the image carrying body by scanning image information in a first direction and then in an opposite second direction within the second area based on a driving frequency associated with the reflected light beam and a time period of an output signal of a sensor disposed within the first area of the image carrying body which senses the deflected light beam of the reference scanning angle within the first area of the image carrying body.

The time period may be calculated as a function of the time elapsed by the reflected light beam moving from a beginning point of the second area of the image carrying body to the position of the reference scanning angle, and the time elapsed by the reflected light beam moving from an ending point of the second area to the position of the reference scanning angle.

The foregoing and/or other aspects of the present general inventive concept may also be achieved by providing a computer readable recording medium having encoded thereon computer instructions that when executed by a computer perform a method of controlling a light scanning unit, including sensing a light beam which is deflected and scanned toward a first non-image sector of an image carrying body by means of a sensor, and calculating a time period of a signal which is outputted from the sensor, and adjusting a horizontal synchronization of the image sector which is scanned in sequence in the first direction and the second direction to correspond to a time period of the signal which is outputted from the sensor.

### BRIEF DESCRIPTION OF THE DRAWINGS

These and/or other aspects of the present general inventive concept will become apparent and more readily appreciated from the following description of the exemplary embodiments, taken in conjunction with the accompanying drawings, in which:

FIG. 1 is a perspective view of a light scanning unit according to an exemplary embodiment of the present general inventive concept;

FIG. 2 is a schematic view illustrating a deflected scanning type of a light beam of the light scanning unit of FIG. 1;

FIG. 3 is a graph illustrating a scanning type of the light beam depending on a driving frequency of a beam deflecting unit and an output period of a sensor of the light scanning unit of FIG. 2;

FIG. 4 is an operating flowchart of the light scanning unit according to the graph of FIG. 3;

FIG. 5 is a graph illustrating a scanning type of a light beam depending on a driving frequency of a beam deflecting unit and an output period of a sensor in a light scanning unit according to an exemplary embodiment of the present general inventive concept;

FIG. 6 is an operating flowchart of the light scanning unit according to the graph of FIG. 5; and

FIG. 7 is a side sectional view of an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

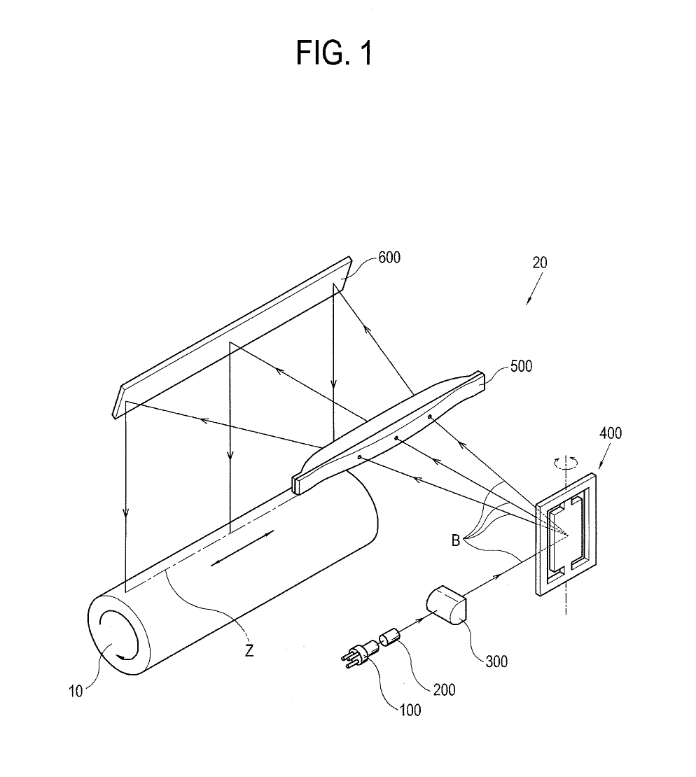

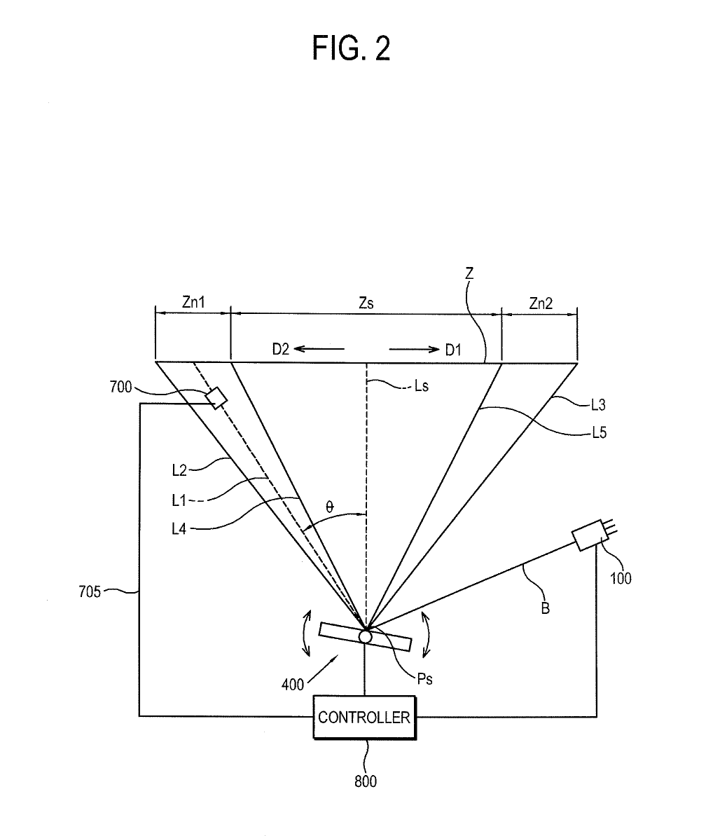

As illustrated in FIGS. 1 and 2, a light scanning unit 20 according to an exemplary embodiment of the present general inventive concept scans a light beam B in a main scanning direction to an image carrying body 10 moving in a sub scanning direction. Also, the light scanning unit 20 reciprocatingly scans the light beam B in the main scanning direction to form a scanning line Z on the image carrying body 10.

Referring to FIG. 2, the scanning line Z is divided into an image sector Zs, and a first non image sector Zn1 and a second non image sector Zn2 are formed at opposite sides of the image sector Zs. The image sector Zs is formed at a central area of the scanning line Z on the image carrying body 10 (referring to FIG. 1), and is a sector to which the light beam B containing predetermined image information is scanned. The first non image sector Zn1 and the second non image sector Zn2 are sectors to which the light beam B, not containing the image information, is scanned. As illustrated in FIG. 2, the first non image sector Zn1 and the second non image sector Zn2 are respectively formed at left and right sides of the image sector Zs. However, this description is only for the purpose of convenience, to illustrate an example of two non image sectors, Zn1 and Zn2, formed at the opposite sides of the image sector Zs. The two non image sectors, Zn1 and Zn2, may be arranged in other configurations along the image sector Zs, as well.

Referring to FIG. 1, the light scanning unit 20 includes a light source 100 generating the light beam B, and a beam deflecting unit 400 deflecting the light beam B emitted from the light source 100 to the image carrying body 10 to form the scanning line Z.

Referring to FIG. 2, the light scanning unit 20 includes a sensor 700 to sense the light beam B deflected by the beam deflecting unit 400 toward the first non image sector Zn1 and to output a sensor output signal 705, and a controller 800 to determine a scanning direction of the light beam B based on the sensor output signal 705 output from the sensor 700, to apply image information to the light source 100 depending on the image information, and adjusting a horizontal synchronization of the image sector Zs.

FIG. 2 will be described below in more detail.

A reference point Ps refers to a point of deflection which is a point at which the light beam B emitted from the light source 100 is reflected by the beam deflecting unit 400 toward the image sector Zs. A reference line Ls, which may be a center reference line, refers to a straight line connecting the reference point Ps and a center of the image sector Zs.

A first direction D1 refers to a direction from the first non image sector Zn1 toward the second non image sector Zn2, that is, a scanning direction facing toward a right side in FIG. 2. A second direction D2 refers to an opposite direction of the first direction D1, that is, a scanning direction facing toward a left side in FIG. 2.

A first line L1 refers to a straight line connecting the reference point Ps and the sensor 700. Here, an angle between the first line L1 and the reference line Ls refers to a reference angle θ.

A second line L2 refers to a straight line connecting an end of the first non image sector Zn1 which does not contact the image sector Zs, and the reference point Ps, and a third line L3 refers to a straight line connecting an end of the second non image sector Zn2 which does not contact the image sector Zs, and the reference point Ps. That is, the second line L2 and the third line L3 refer to straight lines respectively connecting opposite ends of the scanning line Z and the reference point Ps.

A fourth line L4 refers to a straight line connecting an end of the image sector Zs which contacts the first non image sector Zn1, that is, an end of the image sector Zs in the second direction D2, and the reference point Ps. A fifth line L5 refers to a straight line connecting an end of the image sector Zs which contacts the second non image sector Zn2, that is, an end of the image sector Zs in the first direction D1, and the reference point Ps.

The light source 100 is turned on and off by means of the controller 800 to generate and emit at least one light beam B corresponding to an image signal. The light source 100 may be provided as a semiconductor element, such as a laser diode, etc. Also, the light source 100 may emit a single beam or multi beams, depending on a configuration type. For example, if the light source 100 is provided as a semiconductor element having a plurality of light emitting points, the light source 100 may emit multi beams concurrently.

The light source 100 is supplied with image information respectively corresponding to the first direction D1 and the second direction D2 by means of the controller 800 to generate the light beam B containing the image information. That is, when the light beam B is scanned to the image sector Zs in the first direction D1, the light source 100 is supplied with image information corresponding to the first direction D1. On the other hand, when the light beam B is scanned to the image sector Zs in the second direction D2, the light source 100 is supplied with image information corresponding to the second direction D2. When the light beam B is scanned to the first non image sector Zn1 and/or the second non image sector Zn2, the light source 100 is not supplied with the image information.

The beam deflecting unit 400 reciprocatingly scans the light beam B emitted from the light source 100, in detail, the beam deflecting unit 400 scans the light beam B in the first direction D1, and in the second direction D2 opposite thereto, to form the scanning line Z on the image carrying body 10. For this operation, the beam deflecting unit 400 may employ a resonance mirror type. The beam deflecting unit 400 of the resonance mirror type scans the light beam B by vibrating at a predetermined frequency, that is, a driving frequency. The beam deflecting unit 400 may have various known configurations.

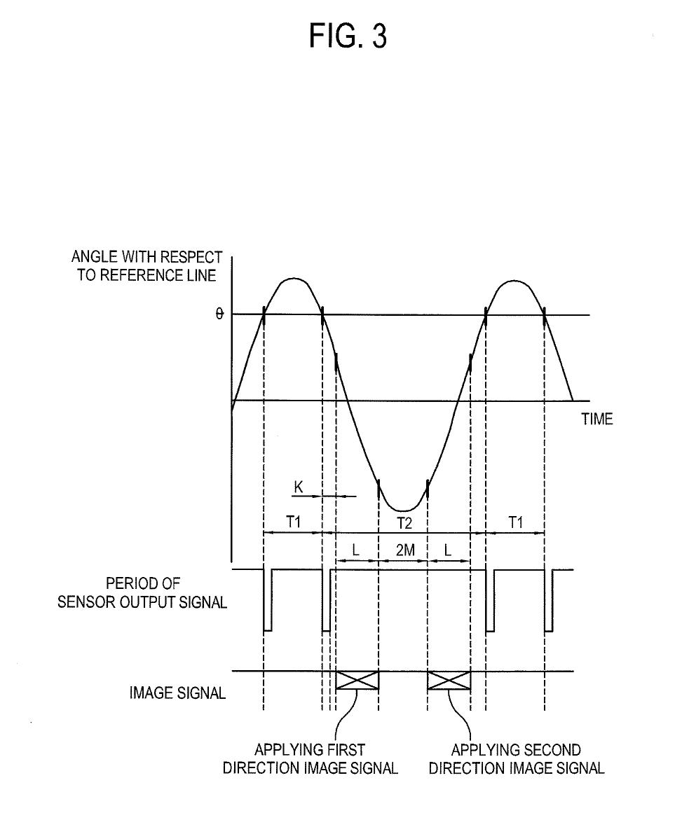

As illustrated in FIG. 3, an angle formed between the light beam B deflected and scanned by the beam deflecting unit 400 and the reference line Ls as the scanning angle of light beam B varies over time forms a sine wave pattern having a predetermined frequency. When the beam deflecting unit 400 is initially driven, the driving frequency is not settled. If a predetermined time elapses so that driving of the beam deflecting unit 400 becomes stabilized after the initial driving, the driving frequency of the beam deflecting unit 400 becomes settled. If the settled frequency is generated from the beam deflecting unit 400, a graph having relative values as illustrated in FIG. 3 may be derived, and based thereon, displacement of a scanning angle of the light beam B (referring to FIG. 2), that is, movement over time according to displacement of an end of the deflected light beam B on the scanning line Z, is calculated. FIG. 3 will be described below in more detail.

Referring to FIG. 1, a collimating lens 200 and a cylindrical lens 300 may be further provided on a path of the light beam B between the light source 100 and the beam deflecting unit 400. Also, an f-θ lens 500 and a scanning line reflecting mirror 600 may be disposed along the path of the light beam B between the beam deflecting unit 400 and the image carrying body 10.

The collimating lens 200 collects the light beam B emitted from the light source 100 to make the light beam B convergent light. That is, the collimating lens 200 may be disposed so that an angle of light beam B in the main scanning direction from the collimating lens 200 to the f-θ lens 500 becomes convergent light and not parallel light, that is, a limited optical system configuration can be provided.

The cylindrical lens 300 has a predetermined refracting force only in the sub scanning direction of light beam B, and rectifies the light beam B passing through the collimating lens 200 to provide image information to the beam deflecting unit 400 which is of a linear type.

The f-θ lens 500 may be provided as a single lens having a light entering plane and a light emitting plane, to correct the beam deflected by the beam deflecting unit 400 to have different powers of magnification with respect to the main scanning direction and the sub scanning direction so that the scanning line Z can be imaged on the image carrying body 10.

The scanning line reflecting mirror 600 is provided to change the path of the light beam B between the beam deflecting unit 400 and the image carrying body 10.

Referring to FIG. 2, the sensor 700 may be disposed between the second line L2 and the fourth line L4, to sense the light beam B scanned along the first line L1 to output a sensor output signal 705. While the light beam B is continuously scanned, the sensor 700 continuously outputs the sensor output signal 705. For this, the sensor 700 may be provided as a photo sensor, or other known sensor. The sensor 700 transmits the outputted sensor output signal 705 to the controller 800, and the controller 800 measures a time period of the sensor output signal 705 outputted from the sensor 700.

The sensor 700 is provided to sense the light beam B scanned to the first non image sector Zn1 of scanning line Z, that is, the light beam B scanned along the first line L1, and the light beam B is not disposed at that time in the second non image sector Zn2.

The controller 800 calculates the data for the scanning angle formed between the light beam B over time with respect to reference line Ls, represented by the graph in FIG. 3, based on the driving frequency of the beam deflecting unit 400 after the driving of the beam deflecting unit 400 is stabilized, and measures the time period of the sensor output signal 705 of the sensor 700. The controller 800 derives data for each movement of the light beam B over time as it moves between the lines, that is, from the first line L1 to the fifth line L5, based on the driving frequency and the time period of the sensor output signal 705 of the sensor 700. Also, the controller 800 determines a scanning direction of the light beam B when the sensor output signal 705 is outputted from the sensor 700, and applies corresponding image information to the light source 100 so that the light beam B, having the image information corresponding to the scanning direction, can be scanned.

FIG. 3 is a graph illustrating a variation of the angle formed between the light path of the light beam B after being deflected by the beam deflecting unit 400 and the reference line Ls over time, and a period of the sensor output signal 705 of the sensor 700 and a point of time of an application of the image signal to the light source 100 corresponding to the period of the sensor output signal 705.

If the driving frequency of the beam deflecting unit 400 is stabilized so that the scanning angle of the light beam B and an angular speed can be settled, the light beam B moves between the lines, that is, the first line L1 to the fifth line L5, to form a sine curve pattern as illustrated in FIG. 3.

T1 refers to a time band during which the light beam B returns to the first line L1 after being scanned from the first line L1 to the second line L2. T1 is the time band where the sine curve illustrated in FIG. 3 is positioned to an upper area of the sine curve pattern above the reference angle θ. During time band T1, the light beam B is scanning a sector entirely within the first non image sector Zn1 of the scanning line Z.

T2 refers to a time band during which the light beam B returns to the first line L1 after being scanned from the first line L1 to the third line L3. T2 is the time band where the sine curve illustrated in FIG. 3 is positioned to a lower area of the sine curve pattern below the reference angle θ.

Since during time band T2, the light beam B is scanning a sector of the scanning line Z that includes the image sector Zs, the relation between time bands T1 and T2 satisfies an inequality T1<T2. Also, while the light beam B is being reciprocatingly scanned in the first direction D1 and the second direction D2, time bands T1 and T2 appear in sequence with respect to a point of time sensed by the sensor 700. Accordingly, the controller 800 can discriminate between the time bands T1 and T2 with respect to the sensor output signal 705 of the sensor 700.

In the present exemplary embodiment, since T1 is the time band during which the light beam B is scanned within the first non image sector Zn1, the image information is not applied to the light source 100 during time band T1. Accordingly, the time band T1 is adopted as a horizontal synchronization reference of the image sector Zs, and a time zone during which to apply image information corresponding to the first direction D1 and the second direction D2 to the light source 100 is divided during the time band T2. Various dividing methods may be employed for this time zone division, and a detailed description of one or more methods will be described below.

The controller 800 measures a time difference of the sensor output signal 705 of the sensor 700 in real time, and determines whether the measured time difference in real time is equal to one of the time bands T1 and T2. For example, when the controller 800 senses the sensor output signal 705 from the sensor 700, if the controller 800 determines that the time difference measured at that point of time is the same as time band T1, the controller 800 applies a division of the time zone designated in advance with respect to the sensing point of time of the sensor output signal 705 to apply the image information corresponding to the direction D1 and the direction D2 to the light source 100, in sequence.

Since the time bands T1 and T2 alternately appear in sequence, an ending point of the time band T1 and a starting point of the time band T2, and a starting point of the time band T1 and an ending point of the time band T2 may be respectively the same point of time. When the sensor output signal 705 is outputted from the sensor 700, if the controller 800 determines that this sensor output signal 705 is the ending point of the time band T1, the controller 800 performs a control operation to apply a time zone division of the time band T2 after this point of time.

A method of adjusting the horizontal synchronization of the image sector Zs in the light scanning unit 20 employing the single sensor 700, according to an exemplary embodiment of the present general inventive concept, will be described below by referring to FIGS. 1 to 4. An initial state is a state in which the light scanning unit 20 is not being driven, but instead is suspended from operation.

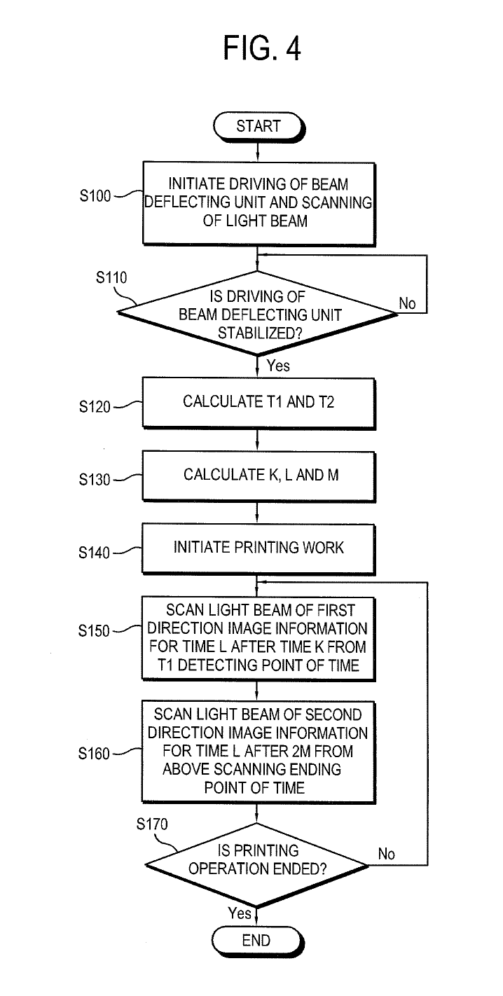

When the light scanning unit 20 starts operating, the beam deflecting unit 400 starts operating, and the light beam B is emitted from the light source 100 so that scanning can be performed (operation S100 of FIG. 4). At this point of time, the controller 800 does not apply the image information to the light source 100.

The controller 800 determines whether the driving of the beam deflecting unit 400 is stabilized so that a settled frequency can be generated, or not (operation S100). If the driving of the beam deflecting unit 400 is stabilized, the controller 800 measures the driving frequency of the beam deflecting unit 400 and the time period of the sensor output signal 705 outputted from the sensor 700, and calculates time bands T1 and T2 (operation S120). Then, as illustrated in FIG. 3, a displacement graph of the angle formed between the path of the light beam B and the reference line Ls as the scanning angle varies over time, and a graph of the period of the sensor output signal 705 of the sensor 700, are both calculated by the controller 800.

The controller 800 divides the time zone of the time band T2 based on the graphs illustrated in FIG. 3. That is, the controller 800 derives a time K during which the light beam B is scanned from the starting point of the time band T2 to the starting point of the image sector Zs, a time L during which the light beam B is scanned to the image sector Zs, and a time M during which the light beam B is scanned to the second non image sector Zn2 based on the driving frequency of the beam deflecting unit 400 and the period of the sensor output signal 705 of the sensor 700 (operation S130).

In further detail, the time K is a time during which the light beam B moves from the first line L1 to the fourth line L4, the time L is a time during which the light beam B moves from the fourth line L4 to the fifth line L5, and the time M is a time during which the light beam B moves from the fifth line L5 to the third line L3. Then, the light beam B returns to the first line L1. The light beam B takes a time 2M to move from the fifth line L5 to the third line L3, and then return to the fifth line L5.

Since a time equal to the sum of times K+L+M, during which the light beam B moves from the first line L1 to the fifth line L5 in the first direction D1, is the same as [time bandT2]/2, the time band T2 can be divided based on the sum of the times K+L+M . That is, after the time K elapses during the time band T2, the light beam B containing the image information of the first direction D1 is scanned during the time L.

Also, after the time 2M and after scanning during the time L is ended, that is, after a time K+L+2M has occurred in the time band T2, the light beam B containing the image information of the second direction D2 is scanned during the time L.

When the times K, L and M are derived by the controller 800, a printing operation is initiated (operation S140). The controller 800 measures the sensor output signal 705 of the sensor 700 in real time, and determines in real time whether a measured time difference is the same as the time of time band T1.

If the controller 800 determines that the time band T1 is ended and the time band T2 is initiated at a starting point of the sensor output signal 705 of the sensor 700, the light beam B having the image information having the first direction D1 is scanned during the time L at a T1 detecting point of time, that is, after the time K from the starting point of the time band T2 (operation S150). When the image information has been fully scanned by the light beam B in the first direction D1, the light beam B having the image information and having the second direction D2 is scanned during the time L after the time 2M has elapsed from the end of the scanning of the image information by the light beam B in the first direction (operation S160).

Then, the controller 800 determines whether the printing operation is completed, and either ends the printing operation if the printing operation is completed, or repeats the above processes until the printing operation is completed, to form an electrostatic latent image of the printing work on the image carrying body 10 (operation S170).

As described above, different time bands T1 and T2 are calculated by the controller 800 based on the driving frequency of the beam deflecting unit 400, and the period of the sensor output signal 705 outputted from the single sensor 700. The time band T1 is adopted as the horizontal synchronization signal, and the time zone of the time band T2 is divided so that the light beam B having the image information and having the first direction D1 and the second direction D2 can be scanned in sequence (that is, the image is first scanned by the light beam B in the first direction D1, then in the second direction D2) using the divided time zone.

Accordingly, the scanning direction of the light beam B which is reciprocatingly scanned can be recognized by means of the single sensor 700, and the horizontal synchronization of the image sector Zs, disposed in parallel in the sub scanning direction, can be accomplished.

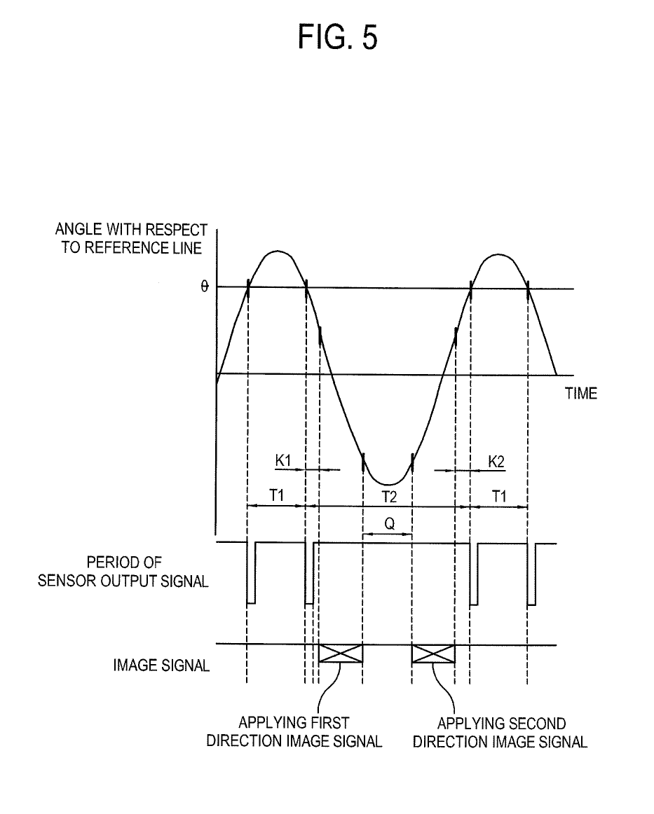

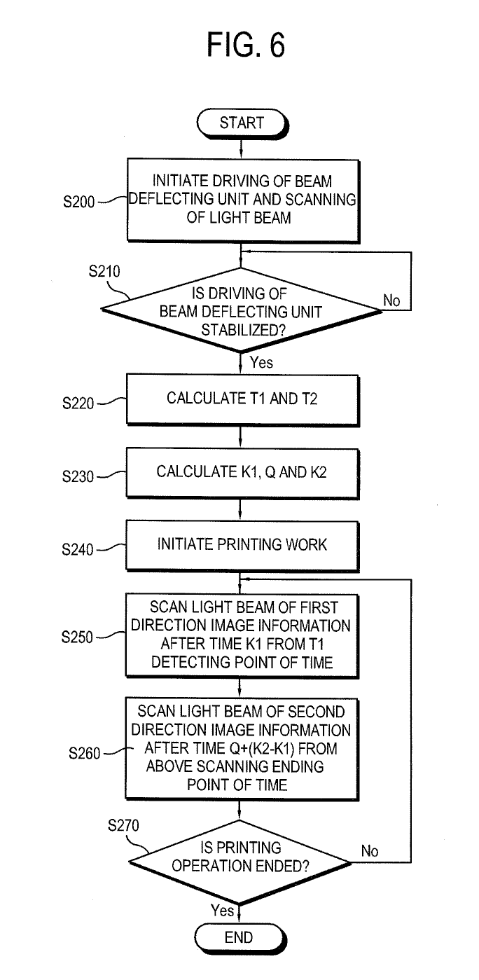

Other various dividing methods may be applied to divide the time band T2 besides the dividing method according to the exemplary embodiment described above with reference to FIGS. 1-4. Hereinafter, another exemplary embodiment of the present general inventive concept employing a dividing method of the time band T2 which is different from the above described exemplary embodiment will be described by referring to FIGS. 5 and 6.

During operations S200 to S220 of FIG. 6, the initiating of the driving of the beam deflecting unit 400 and the scanning of the light beam B, and the calculating of the time bands T1 and T2 based on the driving frequency of the beam deflecting unit 400 and the period of the sensor output signal 705 of the sensor 700 may be the same as described in the exemplary embodiment described above in reference to FIGS. 1-4.

However, now referring to FIG. 5, in another exemplary embodiment a controller 800 divides the time band T2 into a time K1 during which the light beam B is scanned from the starting point of the time band T2 to the starting point of the image sector Zs (referring to FIG. 2), a time Q which is a scanning time between a scanning ending point in the first direction D1 of the image sector Zs and a scanning starting point in the second direction D2, and a time K2 which is a scanning time from a scanning ending point in the second direction D2 of the image sector Zs to the ending point of the time band T2 (operation S230). In this embodiment, a time during which the light beam B moves across the image sector Zs may be a predetermined period of time automatically designated by a system or input by a user, and this period of time may be the same in the first direction D1 and the second direction D2.

It may be desired that the time K1 and the time K2 are the same, but an error between the time K1 and the time K2 may be generated due to, for example, the driving frequency of the beam deflecting unit 400, and other various factors existing in the apparatus. By correcting this error before a scanning of the light beam B having the image information in the second direction D2 is initiated after a scanning of the light beam B having the image information in the first direction D1 is ended, the horizontal synchronization of the image sector Zs is accomplished. That is, by adding a time (K2−K1) to the time Q, the horizontal synchronization of the image sector Zs of the first direction D1 and the second direction D2 can be accomplished.

A time Q+(K2−K1) represents that a time difference between the times K1 and K2 is added to the time Q if the time K2 is bigger than the time K1, and a time difference between the times K1 and K2 is subtracted from the time Q if the time K2 is smaller than the time K1.

If the time zone division of the time band T2 is ended, a printing work may be initiated (operation S240). If the controller 800 recognizes the ending of the time band T1 from the sensor output signal 705 of the sensor 700, the controller 800 scans the light beam B having the image information in the first direction D1 at a point of time when the ending of the time band T1 is detected, that is, after the time K1 from the starting point of the time band T2 (operation S250). If the scanning of the light beam B having the image information in the first direction D1 is ended, the light beam B having the image information in the second direction D2 is scanned after the time Q+(K2−K1) has elapsed from this point of time (operation S260).

Then, the controller 800 determines whether the printing operation is completed or not, and ends the printing operation if the printing operation is completed or repeats the above processes to form a complete electrostatic latent image on the image carrying body 10 (operation S270).

As described above, after calculating the time bands T1 and T2, various methods may be applied to dividing the time band T2 by the time zone.

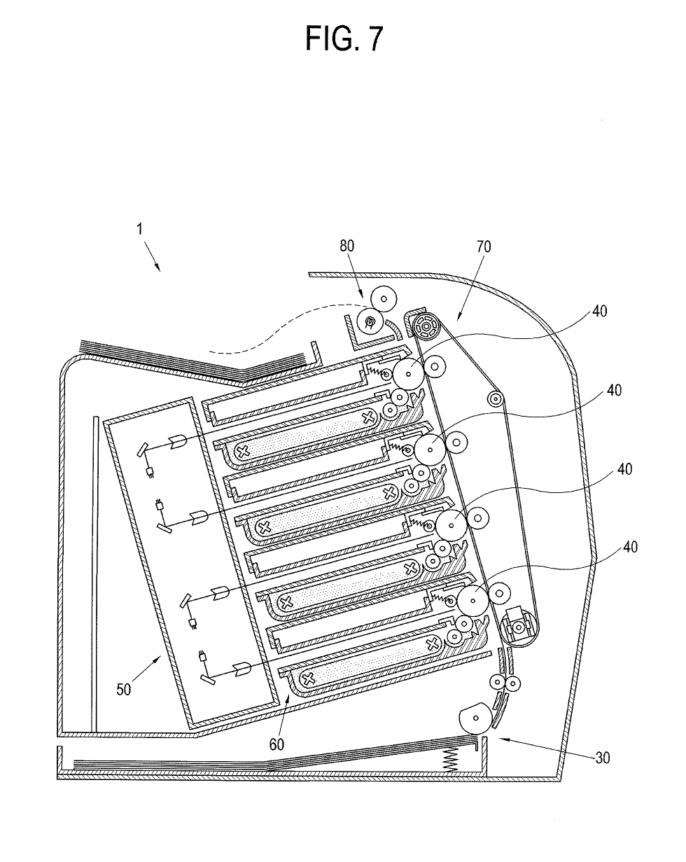

FIG. 7 is a sectional view of an image forming apparatus 1 according to an exemplary embodiment of the present general inventive concept. As illustrated therein, the image forming apparatus 1 according to the exemplary embodiment of the present general inventive concept includes a medium supplying unit 30 to load and supply a printing medium (for example, printing paper), a plurality of image carrying bodies 40 having formed thereon an electrostatic latent image and a visible image by means of a developer, a light scanning unit 50 to form the electrostatic latent image on the image carrying bodies 40, a developing unit 60 to supply the developer to the image carrying bodies 40, a transferring unit 70 to transfer the visible image of the image carrying bodies 40 to the printing medium, and a fusing unit 80 fuse a transferred non fused visible image on the printing medium.

The image carrying bodies 40 includes a plurality of bodies, for example, four bodies corresponding respectively to yellow, magenta, cyan and black colors, disposed in sequence along a transporting path of the printing medium to form a color image on the printing medium. After an outer surface of the image carrying body 40 is uniformly charged by a power source (not illustrated), an electric potential difference is generated by a light beam B of the light scanning unit 50 to form the electrostatic latent image. If the developer is supplied to the image carrying body 40 which has formed thereon the electrostatic latent image from the developing unit 60, the visible image by means of the developer is then formed on the image carrying body 40. Each image carrying body 40 may have the substantially same configuration as the image carrying body 10 (referring to FIG. 1) according to the exemplary embodiments described above.

The light scanning unit 50 scans the light beam B to form the electrostatic latent image on each image carrying body 40. The light scanning unit 50 divides an image information of a color image to be finally formed by each color, and forms the electrostatic latent image on each respective image carrying body 40 based thereon. The light scanning unit 50 may have the substantially same configuration as the light scanning unit 20 (referring to FIG. 1) according to the exemplary embodiments described above.

The developing unit 60 is provided to correspond to the plurality of the image carrying bodies 40 provided by each color developer. Accordingly, the visible image of different colors can be formed on each respective image carrying body 40.

The transferring unit 70 transfers the printing medium to pass through the plurality of image carrying bodies in sequence, and enables the visible image of each image carrying body 40 to be transferred and overlapped on the printing medium.

The fusing unit 80 applies heat and pressure to the printing medium to which the visible image is transferred by the transferring unit 70 to fuse the visible image to the printing medium.

According to the present general inventive concept, a single sensor is employed to sense a horizontal synchronization and a scanning direction of an image sector, thereby simplifying a configuration of an apparatus, and preventing an image deterioration of a printing medium. Accordingly, reliability of a product can be improved, and a cost of an apparatus can be reduced. Also, a number of sensors can be reduced to reduce the complexity of an interface processing a sensor output signal, thereby reducing a processing overhead of a system.

Also, since a horizontal synchronization of an image sector can be performed using a software method to compensate for an error of a driving frequency generated by a beam deflecting unit, which reduces an amount of necessary hardware. Accordingly, the cost of an apparatus can be reduced, and an apparatus can be made small.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A light scanning unit, comprising:
a light source;
a beam deflecting unit which reciprocatingly scans a light beam which is emitted from the light source to form an image sector, and a first non-image sector and a second non-image sector disposed at opposite sides of the image sector;
a sensor which senses the light beam which is deflected and scanned toward the first non-image sector; and
a controller which adjusts a horizontal synchronization of the image sector which is formed by the light beam which is scanned in a first direction and a second direction which is the opposite direction to the first direction based on a time period of a sensor output signal which is outputted from the sensor.

2. The light scanning unit according to claim 1, wherein the controller adjusts a scanning starting point of time and a scanning ending point of time of the light beam of the image sector to correspond to a driving frequency of the beam deflecting unit and the time period of the sensor output signal.

3. The light scanning unit according to claim 2, wherein, if a first line is a line which connects the sensor to a reference point at which an entering light beam is reflected by the beam deflecting unit, a second line is a line which connects the reference point to an end of the first non-image sector which does not contact the image sector, and a third line is a line which connects the reference point to an end of the second non-image sector which does not contact the image sector, and wherein
the controller calculates a time band T1 during which the light beam returns to the first line after being scanned from the first line to the second line, and a time band T2 during which the light beam returns to the first line after moving from the first line to the third line.

4. The light scanning unit according to claim 3, wherein the time bands T1 and T2 satisfy an inequality T1<T2.

5. The light scanning unit according to claim 3, wherein the controller measures a time difference of the sensor output signal in real time, and compares the measured time difference in real time to determine which one of the time bands T1 and T2 is substantially the same as the measured time difference.

6. The light scanning unit according to claim 3, wherein the controller divides a time zone in which the light beam is scanned in the first direction and the second direction in sequence during the time band T2 to form the image sector based on the driving frequency of the beam deflecting unit and the time period of the sensor output signal.

7. The light scanning unit according to claim 6, wherein the time band T2 is divided into:
a time K during which the light beam is scanned from a starting point of the time band T2 to a starting point of the image sector,
a time L during which the light beam is scanned to the image sector, and
a time M during which the light beam is scanned to the second non-image sector.

8. The light scanning unit according to claim 7, wherein the controller measures the time difference of the sensor output signal in real time, and scans for the time L the light beam which comprises an image information which corresponds to the first direction after the time K from the starting point of the time band T2 if the measured time difference is substantially the same as the time band T1.

9. The light scanning unit according to claim 1, wherein the beam deflecting unit comprises a resonance mirror.

10. An image forming apparatus, comprising:
an image carrying body;
a light scanning unit to scan a light beam to the image carrying body to form a latent image, the light scanning unit comprising
a light source;
a beam deflecting unit which reciprocatingly scans a light beam which is emitted from the light source to form an image sector on the image carrying body, and a first non-image sector and a second non-image sector disposed at opposite sides of the image sector on the image carrying body;
a sensor which senses the light beam which is deflected and scanned toward the first non-image sector; and
a controller which adjusts a horizontal synchronization of the image sector which is formed on the image carrying body by the light beam which is scanned in a first direction and a second direction which is the opposite direction to the first direction based on a time period of a sensor output signal which is outputted from the sensor;
a developing unit to supply a developer to the image carrying body to form a visible image thereon;
a transferring unit to transfer the visible image of the image carrying body to a printing medium; and
a fusing unit to fuse the visible image on the printing medium.

11. The image forming apparatus according to claim 10, wherein the beam deflecting unit comprises a resonance mirror.

12. A control method of a light scanning unit which includes a light source, and a beam deflecting unit which reciprocatingly scans a light beam which is emitted from the light source in a first direction and a second direction which is the opposite direction to the first direction to form an image sector and first and second non-image sectors disposed at opposite sides of the image sector, the control method of the light scanning unit comprising:
sensing the light beam which is deflected and scanned toward the first non-image sector by means of a sensor, and calculating a time period of a sensor output signal which is outputted from the sensor; and
adjusting a horizontal synchronization of the image sector which is scanned in sequence in the first direction and the second direction to correspond to the time period of the sensor output signal.

13. The control method of the light scanning unit according to claim 12, wherein the adjusting the horizontal synchronization comprises adjusting a scanning starting point of time and a scanning ending point of time of the light beam of the image sector to correspond to a driving frequency of the beam deflecting unit and the time period of the sensor output signal.

14. The control method of the light scanning unit according to claim 13, wherein, if a first line is a line which connects the sensor to a reference point at which an entering light beam is reflected by the beam deflecting unit, a second line is a line which connects the reference point to an end of the first non image sector which does not contact the image sector, and a third line is a line which connects an end of the second non image sector which does not contact the image sector to the reference point, and wherein
the calculating the time period comprises calculating a time band T1 during which the light beam returns to the first line after being scanned from the first line to the second line, and a time band T2 during which the light beam returns to the first line after moving from the first line to the third line.

15. The control method of the light scanning unit according to claim 14, wherein the adjusting the horizontal synchronization comprises:
measuring the time difference of the sensor output signal in real time, and
scanning the light beam which comprises an image information which corresponds to the first direction to the image sector after the time K1 from the starting point of the time band T2 if the measured time difference is substantially the same as the time band T1.

16. The control method of the light scanning unit according to claim 15, wherein the adjusting the horizontal synchronization further comprises:
scanning the light beam which comprises an image information which corresponds to the second direction to the image sector after a time Q+(K2−K1) from the scanning ending point of the first direction of the light beam.

17. The control method of the light scanning unit according to claim 12, wherein the beam deflecting unit comprises a resonance mirror.

18. A method to control a light scanning unit of an image forming device, comprising:
calculating a scanning angle pattern of a reflected light beam which moves over time with reference to a reference scanning angle as the reflected light beam reciprocatingly moves from a first area of an image carrying body to a second and then a third area of the image carrying body; and
controlling the reflected light beam to form a latent image only on the second area of the image carrying body by scanning image information in a first direction and then in an opposite second direction within the second area based on a driving frequency associated with the reflected light beam and a time period of an output signal of a sensor disposed within the first area of the image carrying body which senses the deflected light beam of the reference scanning angle within the first area of the image carrying body.

19. The method of claim 18, wherein the time period is calculated as a function of the time elapsed by the reflected light beam moving from a beginning point of the second area of the image carrying body to the position of the reference scanning angle, and the time elapsed by the reflected light beam moving from an ending point of the second area to the position of the reference scanning angle.

20. A computer readable recording medium having encoded thereon computer instructions that when executed by a computer perform a method of controlling a light scanning unit, comprising:
sensing a light beam which is deflected and scanned toward a first non-image sector of an image carrying body by means of a sensor, and calculating a time period of a signal which is outputted from the sensor; and
adjusting a horizontal synchronization of the image sector which is scanned in sequence in the first direction and the second direction to correspond to a time period of the signal which is outputted from the sensor.
